(19) United States
(12) Patent Application Publication
(10) Pub. No.: US 2015/0189698 A1
(43) Pub. Date: Jul. 2, 2015

(54) INVISIBLE LIGHT EMITTING DEVICE

(71) Applicants: Cheng WEN, Taipei (TW); Chen-sin Liu, Taipei City (TW)

(72) Inventors: Cheng WEN, Taipei (TW); Chen-sin Liu, Taipei City (TW)

(21) Appl. No.: 14/339,464

(22) Filed: Jul. 24, 2014

(30) Foreign Application Priority Data
Dec. 30, 2013 (TW) 102149107

(51) Int. Cl. H05B 3/00

(52) U.S. Cl. CPC H05B 3/0085; H05B 3/009

(57) ABSTRACT

An invisible light emitting device includes a thermal radiation emitting component and a light converting component. The thermal radiation emitting component is configured to provide first invisible light and thermal energy. The light converting component covers a light emitting surface of the thermal radiation emitting component. The light converting component includes a first light transmission body and light converting material disposed in the first light transmission body. The light converting material is configured to provide second invisible light by absorbing the first invisible light and thermal energy from the thermal radiation emitting component. The invisible light emitting device can rapidly provide the second invisible light and has a longer lifetime. In addition, the radiation intensity distribution of the invisible light emitting device can be controlled by adjusting optical design of the first light transmission body.

### FIELD OF THE INVENTION

The invention relates to a light emitting device, and more particularly to an invisible light emitting device.

### BACKGROUND OF THE INVENTION

In recent years, with advances in modern technology, physical energy of sound, light, thermal, electricity, magnetic and radiation become more used in medical treatment, among which the far infrared light which belongs to the invisible light is much more commonly used in physical therapy.

In nature, there are materials (a far infrared light ceramic material, for instance) that can emit the infrared light spontaneously. The radiation intensity of the far infrared light emitted of these materials is related to their material property and their surface temperature. Among the same material, the higher the surface temperature, the higher the radiation intensity of the far infrared light emitted. In the conventional technique, the emitting source of the far infrared light can be classified into a non-heated type and a heated type. The far infrared light emitting material of the non-heated type emitting source can absorb energy from the environment or the human body contacting the far infrared light emitting material. Since the temperature of the environment or the human body is relatively lower, the excited far infrared light is relatively weak. The far infrared light emitting material of the heated emitting source is heated by the thermal energy conducted from an electric heating element to elevate the surface temperature of the far infrared light emitting material, thereby enabling the far infrared light emitting material to be emitting the far infrared light with sufficient radiation intensity. For example, a heater strip or a thermal resistance film is wrapped around by the far infrared light emitting material.

However, the heating rate of thermal conduction through the heater strip or the thermal resistance film is relatively slower. In addition, the lifetime of the heater strip or the thermal resistance film is relatively shorter, about several thousands of hours. Furthermore, in the conventional technology, the thermal radiation and the far infrared light from the heater strip or the thermal resistance film can't be efficiently converged.

### SUMMARY OF THE INVENTION

The invention provides an invisible light emitting device which has longer lifetime and can rapidly generate invisible light, and radiation intensity distribution of the invisible light can be controlled.

In order to achieve at least one of the above-mentioned or other advantages, an embodiment of the invention provides an invisible light emitting device which includes a thermal radiation emitting component and a light converting component. The thermal radiation emitting component is configured to provide first invisible light, wherein the light converting component covers a light emitting surface of the thermal radiation emitting component. The light converting component includes a first light transmission body and a light converting material disposed in the first light transmission body. The light converting material is configured to absorb the first invisible light to emit second invisible light. The invisible light emitting device can rapidly provide the second invisible light and has a longer lifetime. In addition, the radiation intensity distribution of the invisible light emitting device can be controlled by adjusting optical design of the first light transmission body.

In an embodiment of the invention, the invisible light emitting device, for example, further includes a substrate which has a first surface and a second surface opposite to the first surface, wherein the thermal radiation emitting component and the light converting component are disposed on the first surface.

In an embodiment of the invention, the invisible light emitting device, for example, further includes a second light transmission body disposed on the first surface of the substrate, and covering the light converting component.

In an embodiment of the invention, the invisible light emitting device, for example, further includes a second light transmission body disposed on the first surface of the substrate, wherein the second light transmission body is located between the thermal radiation emitting component and the light converting component. Further, the thermal radiation emitting component may further provide thermal energy, the thermal energy is conducted to the light converting material through the second light transmission body and the first light transmission body, and the light converting material is also configured to absorb the thermal energy to emit the second invisible light.

In an embodiment of the invention, the invisible light emitting device, for example, further includes a heat dissipation component disposed on the second surface of the substrate.

In an embodiment of the invention, the heat dissipation component, for example, includes a thermal converting material configured to absorb thermal energy to emit a third invisible light.

In an embodiment of the invention, the first invisible light, for example, includes near infrared light, and the second invisible light and the third invisible light, for example, include far infrared light.

In an embodiment of the invention, a wavelength of the first invisible light is, for example, between 700 nm-1400 nm, and a wavelength of the second invisible light is, for example, between 4 μm-1000 μm.

In an embodiment of the invention, the light converting material, for example, includes a plurality of dots distributed in the first light transmission body.

In an embodiment of the invention, the dots are powders.

In an embodiment of the invention, the thermal radiation emitting component, for example, includes a light-emitting diode.

In an embodiment of the invention, the light-emitting diode is an infrared light-emitting diode.

In an embodiment of the invention, the light converting material, for example, includes a far-infrared radiation material.

In an embodiment of the invention, the thermal radiation emitting component, for example, further provides thermal energy, the thermal energy is conducted to the light converting material through the first light transmission body, and the light converting material is also configured to absorb the thermal energy to emit the second invisible light.

In the invisible light emitting device of the invention, the thermal radiation emitting component is used to emit the first invisible light, and the first invisible light is transmitted to the light converting material through the first light transmission body to heat the light converting material by thermal radiation. Compared to the conventional technique that the light converting material is heated by the thermal conduction, the thermal radiation can rapidly heat the light converting material, so that the invisible light emitting device of the invention can rapidly provide the second invisible light. Furthermore, in one embodiment of the invention, the thermal radiation emitting component can further provide thermal energy, and the thermal energy is transmitted to the light converting material through the first light transmission body by thermal conduction. Since both the thermal radiation and the thermal conduction can be used to heat the light converting material, the invisible light emitting device of the invention can more rapidly provide the second invisible light. Furthermore, compared to the conventional technique, the invisible light emitting device of the invention has a longer lifetime and can intensify the radiation intensity of the second invisible light by using specific optical design to converge the second invisible light in a limited scope.

### BRIEF DESCRIPTION OF THE DRAWINGS

The invention will become more readily apparent to those ordinarily skilled in the art after reviewing the following detailed description and accompanying drawings, in which:

FIG. 1 is a schematic diagram of an invisible light emitting device of an embodiment of the invention.

FIG. 2 is a schematic diagram of an invisible light emitting device of another embodiment of the invention.

FIG. 3 is a schematic diagram of an invisible light emitting device of yet another embodiment of the invention.

### DETAILED DESCRIPTION OF PREFERRED EMBODIMENTS

A far infrared light emitting device is taken for example to particularly describe the invisible light emitting device of the invention. It should be noted that the invisible light emitting device of the invention is not limited to the far infrared light emitting device. In addition, a thermal radiation emitting component of the invention is not limited to a near infrared light light-emitting diode.

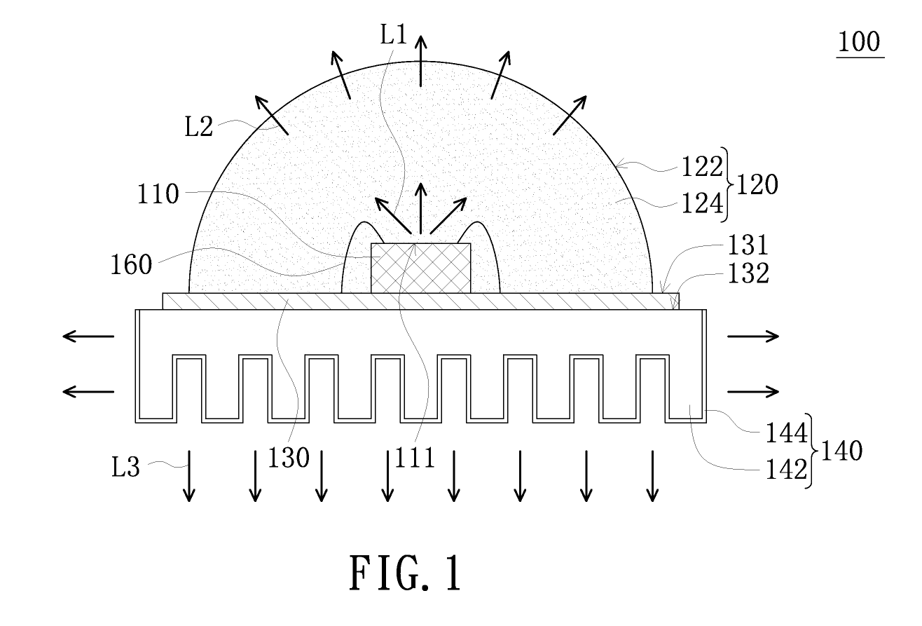

FIG. 1 is a schematic diagram of an invisible light emitting device of an embodiment of the invention. Referring to FIG. 1, the invisible light emitting device 100 includes a thermal radiation emitting component 110 and a light converting component 120, wherein the thermal radiation emitting component 110 is configured to provide first invisible light L1. The light converting component 120 covers a light emitting surface 111 of the thermal radiation emitting component 110. The light converting component 120 includes a first light transmission body 122 and a light converting material 124 disposed in the first light transmission body 122. The light converting material 124 is configured to absorb the first invisible light L1 to emit a second invisible light L2.

In the illustrated embodiment, the invisible light emitting device 100, for example, further includes a substrate 130 which has a first surface 131 and a second surface 132 opposite to the first surface 131. The thermal radiation emitting component 110 and the light converting component 120 are disposed on the first surface 131 of the substrate 130. The substrate 130 is, for example, a circuit board, wherein the thermal radiation emitting component 110 is electrically connected to the substrate 130, and thus, the substrate 130 can drive the thermal radiation emitting component 110 to provide the first invisible light L1. In the illustrated embodiment, the substrate 130 and the thermal radiation emitting component 110 are electrically connected by a bonding wire 160 of the invisible light emitting device 100, but the manner to electrically connect the substrate 130 and the thermal radiation emitting component 110 is not limited to using the bonding wire 160.

In the illustrated embodiment, the thermal radiation emitting component 110 is, for instance, a near infrared light-emitted diode, wherein the first invisible light L1 provided by the thermal radiation emitting component 110 is near infrared light having a wavelength between about 700 nm-1400 nm. In addition, the light converting material 124, for example, includes a plurality of dots distributed in the first light transmission body 122. The light converting material 124 is a far-infrared radiation material, for instance. The light converting material 124 is configured to absorb the thermal energy of the first invisible light L1 to emit the second invisible light L2. The second invisible light L2 is, for example, far infrared light having a wavelength between about 4 μm-1000 μm.

In the illustrated embodiment, when the thermal radiation emitting component 110 is driven to be turned on, the first invisible light L1 would be emitted from the thermal radiation emitting component 110. The first invisible light L1 is the near infrared light and it can efficiently radiate the thermal energy produced by the thermal radiation emitting component 110 because of the heat radiation property of the infrared light. When the first invisible light L1 strikes the light converting material 124, the inner molecules of the light converting material 124 vibrate and perform energy converting function, thereby emitting the second invisible light L2.

In addition, in the illustrated embodiment, after the thermal radiation emitting component 110 is driven to be turned on, it may further emit thermal energy (not shown). The first light transmission body 122 is served as a medium to transmit the thermal energy to the light converting material 124 in a manner of thermal conduction, thereby making the light converting material 124 perform energy converting function to emit the second invisible light L2. Compared to the conventional technique of having the light converting material to be heated by the thermal conduction, the thermal radiation can rapidly heat the light converting material 124 of the illustrated embodiment, so that the invisible light emitting device 100 of the embodiment can rapidly provide the second invisible light L2. Furthermore, the thermal radiation emitting component 110 can further provide the thermal energy, and the thermal energy is transmitted to the light converting material 124 through the first light transmission body 122 by thermal conduction. Since both the thermal radiation and the thermal conduction can be used to heat the light converting material 124, the invisible light emitting device 100 of the embodiment can more rapidly provide the second invisible light L2. Furthermore, since the thermal radiation emitting component 110 has a lifetime or lifespan about several tens of thousands hours, the invisible light emitting device 100 has a longer lifetime. In addition, in the invisible light emitting device 100 of the embodiment, the emitting shape of the second invisible light L2 can be adjusted to meet the requirement through adjusting the shape design of the first light transmission body 122. For instance, the shape of the first light transmission body 122 can be designed to a shape capable of converging light, so that the second invisible light L2 can be condensed in a limited scope (or minute spot) to intensify the radiation intensity in the limited scope.

The invisible light emitting device 100 can further include a heat dissipation component 140 disposed on a second surface 132 of the substrate 130, wherein the second surface 132 is opposite to the first surface 131 of the substrate 130. The heat dissipation component 140 is configured to dissipate heat from the thermal radiation emitting component 110. The heat dissipation component 140, for example, includes a passive heat dissipation component 142, such as a heat sink. In addition, to further utilize the thermal energy produced by the thermal radiation emitting component 110, the heat dissipation component 140 can further include a thermal converting material 144 which is configured to absorb the thermal energy conducted to the passive heat dissipation component 142, and then emits a third invisible light L3. The thermal converting material 144 is, for example, a far-infrared radiation material, and the emitted third invisible light L3 is the far infrared light. In the illustrated embodiment, the thermal converting material 144, for example, is a layer coated on the surface of the passive heat dissipation component 142, but the invention is not limited to this. For instance, the thermal converting material 144 can includes a plurality of dots distributed on the surface of the passive heat dissipation component 142 or in the passive heat dissipation component 142. In addition, the dots are, for example, powders.

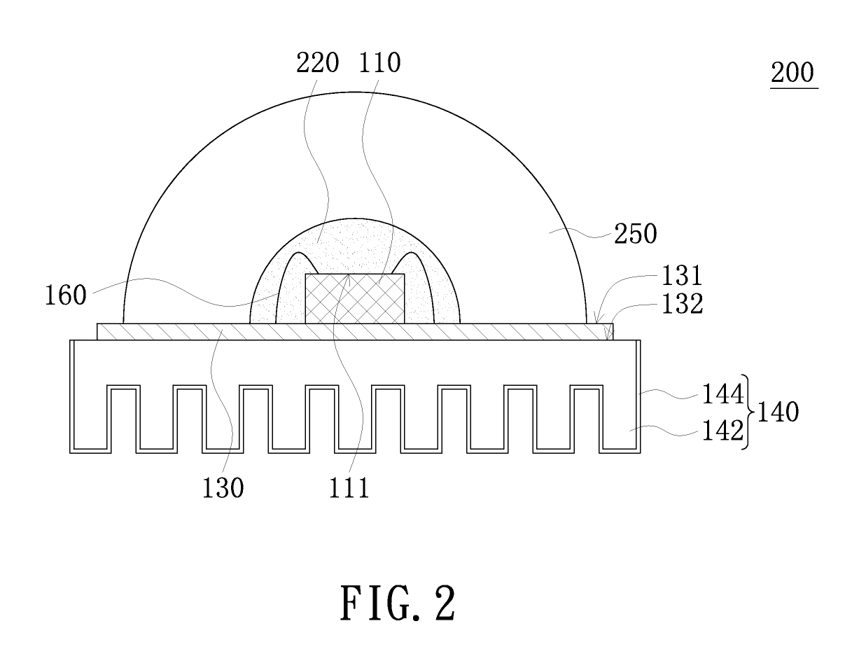

FIG. 2 is a schematic diagram of an invisible light emitting device of an another embodiment of the invention. Referring to FIG. 2, the structure and the advantages of the invisible light emitting device 200 are similar to the invisible light emitting device 100, only the differences will be described below. Compared to the invisible emitting device 100 mentioned above, the invisible light emitting device 200 of the another embodiment further includes a second light transmission body 250 disposed on the first surface 131 of the substrate 130. The second light transmission body 250 covers a light converting component 220. The light converting component 220 is similar to the light converting component 120, and therefore detailed description for the light converting component 220 is omitted. The second light transmission body 250 can be, but not limited to, made of a light transmission packaging material. In the embodiment, the second light transmission body 250 can be designed to adjust the emitting shape of the second invisible light L2. In the another embodiment, the second light transmission body 250, for example, is made of a pure light transmitting packaging material without the light converting material 124. As a result, the second light transmission body 250 is more suitable to be designed to adjust the emitting shape of the second invisible light L2.

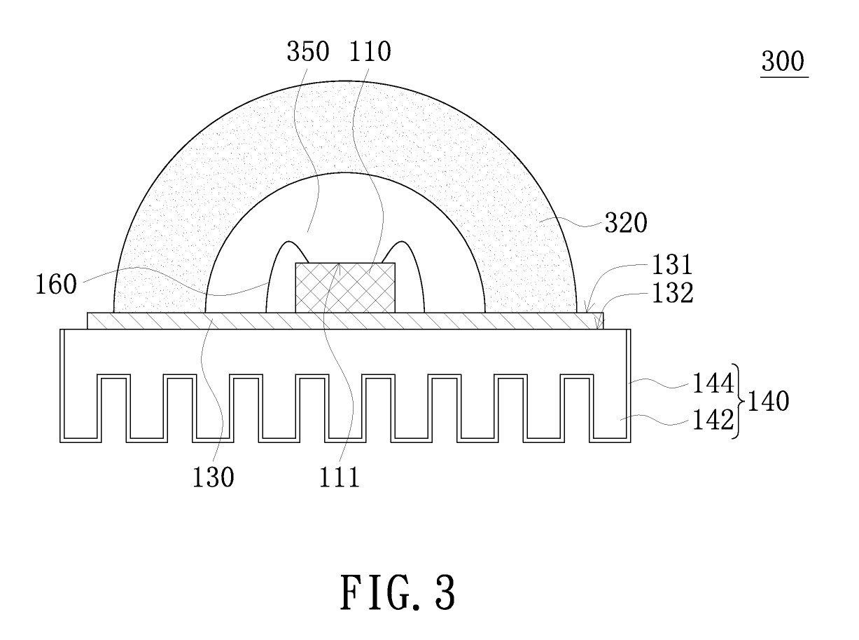

FIG. 3 is a schematic diagram of an invisible light emitting device of yet another embodiment of the invention. Referring to FIG. 3, the structure and the advantages of the invisible light emitting device 300 are similar to the invisible light emitting device 100. The difference is that the invisible light emitting device 300 further includes a third light transmission body 350 disposed on the first surface 131 of the substrate 130. The third light transmission body 350 is located between the thermal radiation emitting component 110 and a light converting component 320. The light converting component 320 is similar to the light converting component 120 mentioned above, and detailed description for the light converting component 320 is omitted.

In summary, in the invisible light emitting device of the invention, the thermal radiation emitting component is used to emit a first invisible light, and the first invisible light is transmitted to the light converting material through the first light transmission body to heat the light converting material by thermal radiation. Compared to the conventional technique of having the light converting material to be heated by the thermal conduction, the thermal radiation can rapidly heat the light converting material, so that the invisible light emitting device of the invention can rapidly provide a second invisible light. Furthermore, in one embodiment of the invention, the thermal radiation emitting component can further provide thermal energy, and the thermal energy is transmitted to the light converting material through the first light transmission body by thermal conduction. Since both the thermal radiation and the thermal conduction can be used to heat the light converting material, the invisible light emitting device of the invention can more rapidly provide the second invisible light. Furthermore, compared to the conventional technique, the invisible light emitting device of the invention has a longer lifetime and can intensify the radiation intensity of the second invisible light by using specific optical design to condense the second invisible light in a limited scope.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An invisible light emitting device, comprising:
a thermal radiation emitting component configured to provide a first invisible light, the thermal radiation emitting component comprising a light emitting surface; and
a light converting component, comprising:
a first light transmission body covering the light emitting surface of the thermal radiation emitting component; and
a light converting material disposed in the first light transmission body, wherein the light converting material is configured to absorb the first invisible light to emit a second invisible light.

2. The invisible light emitting device according to claim 1, further comprising a substrate which has a first surface and a second surface opposite to the first surface, wherein the thermal radiation emitting component and the light converting component are disposed on the first surface.

3. The invisible light emitting device according to claim 2, further comprising a second light transmission body disposed on the first surface of the substrate and covering the light converting component.

4. The invisible light emitting device according to claim 2, further comprising a third light transmission body disposed on the first surface of the substrate, wherein the third light transmission body is located between the thermal radiation emitting component and the light converting component.

5. The invisible light emitting device according to claim 2, further comprising a heat dissipation component disposed on the second surface of the substrate.

6. The invisible light emitting device according to claim 5, wherein the heat dissipation component comprises a thermal converting material configured to absorb thermal energy to emit a third invisible light.

7. The invisible light emitting device according to claim 6, wherein the third invisible light comprises far infrared light.

8. The invisible light emitting device according to claim 1, wherein the first invisible light comprises near infrared light, and the second invisible light comprises far infrared light.

9. The invisible light emitting device according to claim 1, wherein a wavelength of the first invisible light is between 700 nm-1400 nm, and a wavelength of the second invisible light is between 4 μm-1000 μm.

10. The invisible light emitting device according to claim 1, wherein the light converting material comprises a plurality of dots distributed in the first light transmission body.

11. The invisible light emitting device according to claim 1, wherein the dots are powders.

12. The invisible light emitting device according to claim 1, wherein the thermal radiation emitting component comprises a light-emitting diode.

13. The invisible light emitting device according to claim 12, wherein the light-emitting diode is an infrared light-emitting diode.

14. The invisible light emitting device according to claim 1, wherein the light converting material comprises a far-infrared radiation material.

15. The invisible light emitting device according to claim 1, wherein the thermal radiation emitting component further provides thermal energy, the thermal energy is conducted to the light converting material through the first light transmission body, and the light converting material is also configured to absorb the thermal energy to emit the second invisible light.

16. The invisible light emitting device according to claim 4, wherein the thermal radiation emitting component further provides thermal energy, the thermal energy is conducted to the light converting material through the second light transmission body and the first light transmission body, and the light converting material is also configured to absorb the thermal energy to emit the second invisible light.
